(19) United States
(12) Patent Application Publication
(10) Pub. No.: US 2005/0047285 A1
(43) Pub. Date: Mar. 3, 2005

(54) Optical disc drive

(76) Inventor: Chung-Ping Chuang, Taipei City (TW)

Correspondence Address: RABIN & Berdo, PC, 1101 14TH STREET, NW, SUITE 500, WASHINGTON, DC, 20005, US

(21) Appl. No.: 10/923,846

(22) Filed: Aug. 24, 2004

(30) Foreign Application Priority Data
Aug. 25, 2003 (TW) 092123333

(51) Int. Cl. G11B 7/085

(52) U.S. Cl. 369/30.27

(57) ABSTRACT

An optical disc drive including a triggering switch and a control unit is disclosed. The triggering unit outputs a triggering signal while it is forced. The control unit, which is electrically coupled with a disc-ejection motor and the triggering switch, receives the triggering signal, and outputs a disc-ejection motor control signal when an optical disc rotates in the optical disc drive. The disc-ejection motor outputs a force opposite to the applied force while receiving the disc-ejection motor control signal so that the tray is restrained in the optical disc drive.

This application claims the benefit of Taiwan application Serial No. 92123333, filed Aug. 25, 2003, the subject matter of which is incorporated herein by reference.

### BACKGROUND OF THE INVENTION

1. Field of the Invention

The invention relates in general to an optical disc drive, and more particularly to a tray-type optical disc drive with emergency disc-ejection mechanism.

2. Description of the Related Art

With the rapid growth in information volume, most multimedia products are issued in the form of optical discs. Further, due to the growing popularity of consumer discs, the optical disc drive has become an essential piece of equipment for computers. Therefore, the optical disc drive really plays a very important role in multimedia products.

FIG. 1 is a schematic diagram of a conventional disc drive, showing a disc drive 100 in part. The conventional disc drive 100 mainly includes a spindle motor 110, a driven module including a cam 120, a disc-ejection motor 130, an emergency disc-ejection element 140.

The spindle motor 110 is disposed in the optical disc drive 100 for rotating an optical disc (not shown in the diagram). The driven module including the cam 120 is coupled to the tray 150, while the disc-ejection motor 130 is coupled to the driven module. When the optical disc drive 100 is out of order, i.e., the function key on the front panel which controls the release of the tray 150 is not working, the tray 150 still can be released from the optical disc drive by using a mechanical method to eject the optical disc.

The above mechanical method for ejecting the optical disc requires an emergency disc-ejection element 140 to be installed in the optical disc drive, opposite to the cam 120 of the driven module. Any linear unit such as a rod can be inserted into an emergency disc-ejection hole on the front panel along the arrow direction shown in the diagram. Pushing the rod will push the emergency disc-ejection element 140 so as to drive the cam 120 of the driven module to withdraw the tray 150 from the optical disc drive 100.

However, a problem arises in the practical application of the above method: if something like a rod or a paper clip was inserted into the emergency disc-ejection hole when the optical disc drive 100 is reading an optical disc, the tray 150 containing an optical disc which rotates in a high speed will be forced to be released from the optical disc drive. This will cause damage to the optical disc which is being read or burnt. Worse than that, the optical disc rotating in high-speed might be ejected from the optical disc drive 100 and might even hurt the user.

### SUMMARY OF THE INVENTION

It is therefore an object of the invention to provide an optical disc drive with disc-ejection safety protection. According to the invention, the optical disc drive prevents a rotating optical disc, which may be read by the optical disc drive, from being damaged or from hurting the user when the emergency disc-ejection element is pushed by mistake.

To achieve the above-identified object the invention provides an optical disc drive which at least includes a driven module coupled to a tray, a disc-ejection motor coupled to the driven module, an emergency disc-ejection element which provides the driven module with an applied force to withdraw the tray from the optical disc drive when pushed to the top, a triggering switch for outputting a triggering signal corresponding to the applied force, and a control unit for receiving the triggering signal and outputting a disc-ejection motor control signal when the optical disc rotates in the optical disc drive. The disc-ejection motor outputs a force opposite to the applied force while receiving the disc-ejection motor control signal so that the tray is restrained in the optical disc drive.

To achieve the above-identified object a second disc drive is provided. In addition to all the elements included in the first disc drive, the second disc drive further includes a spindle motor, which is disposed in the optical disc drive and is electrically coupled with the control unit, for driving the optical disc. The control unit receives a triggering signal and outputs a spindle motor control signal while the optical disc rotates. In addition, the spindle motor receives a spindle motor control signal and accordingly outputs a reverse torque which reduces the rotation speed of the optical disc. After that, the disc-ejection motor discharges the reverse force to release the tray from the optical disc drive.

To achieve the above-identified object the invention provides a third disc drive including at least a spindle motor disposed in the optical disc drive for driving the optical disc to rotate, a driven module coupled to a tray, an emergency disc-ejection element which provides the driven module with an applied force to withdraw the tray from the optical disc drive when pushed to the top, a triggering switch for outputting a triggering signal corresponding to the applied force, and a control unit which is electrically coupled with the spindle motor and the triggering switch for receiving the triggering signal and outputting a spindle motor control signal when the optical disc rotates in the optical disc drive. In addition, the spindle motor receives a spindle motor control signal and accordingly outputs a reverse torque which reduces the rotation speed of the optical disc.

Other objects, features, and advantages of the invention will become apparent from the following detailed description of the embodiments. The following description is made with reference to the accompanying drawings.

### BRIEF DESCRIPTION OF THE DRAWINGS

FIG. 1 is a schematic diagram of a conventional optical disc drive.

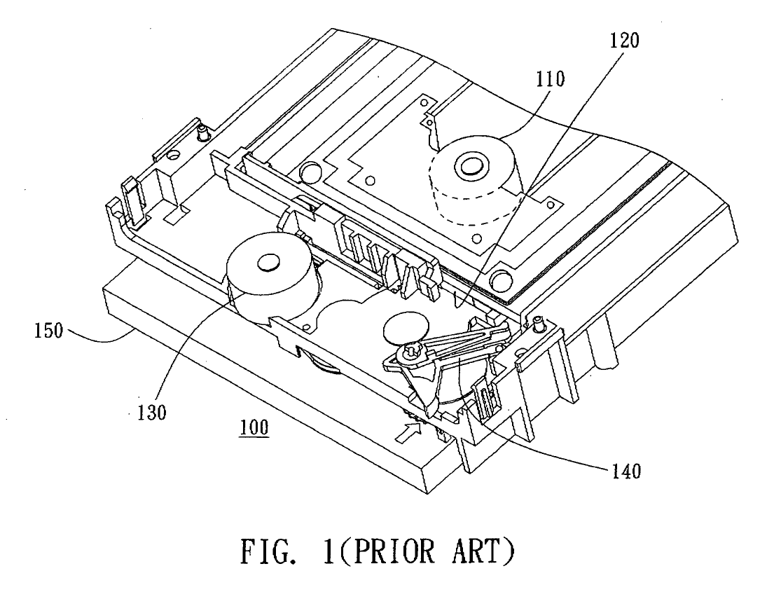

FIG. 2 is a schematic diagram of an optical disc drive according to the invention.

FIG. 3A is a block diagram of an optical disc drive according to embodiment one of the invention.

FIG. 3B is an emergency disc-ejection control method for an optical disc drive according to embodiment one of the invention.

FIG. 4A is a block diagram of an optical disc drive according to embodiment two of the invention.

FIG. 4B is an emergency disc-ejection control method for an optical disc drive according to embodiment two of the invention.

FIG. 5A is a block diagram of an optical disc drive according to embodiment three of the invention.

FIG. 5B is an emergency disc-ejection control method for an optical disc drive according to embodiment three of the invention.

### DETAILED DESCRIPTION OF THE INVENTION

Embodiment One:

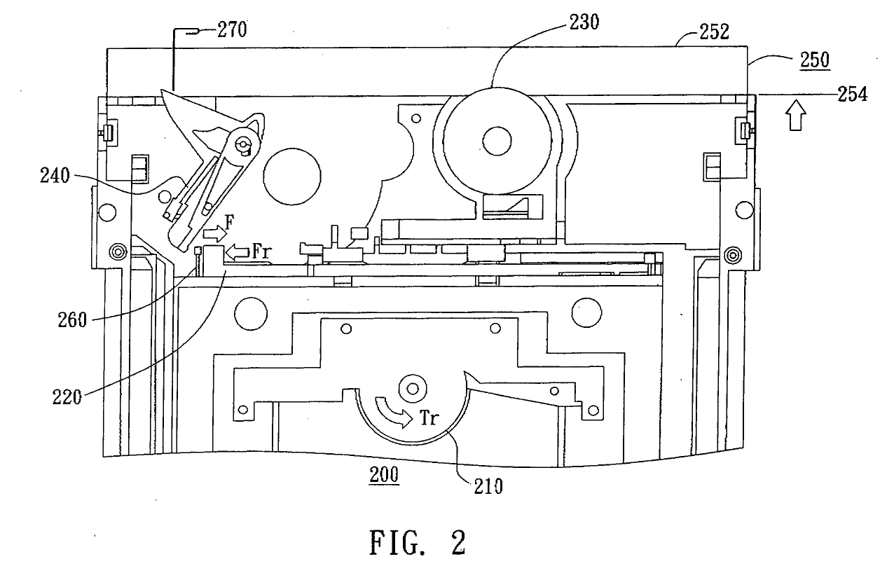

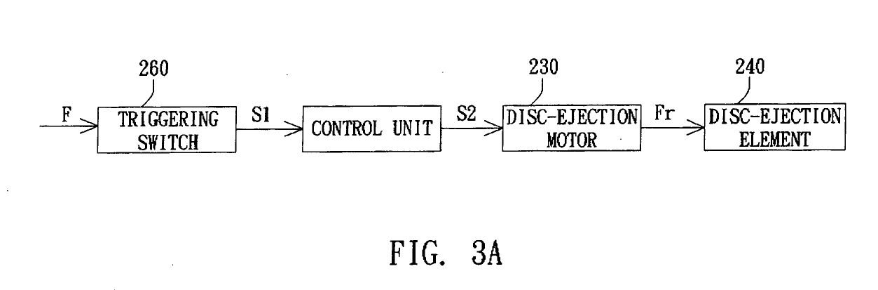

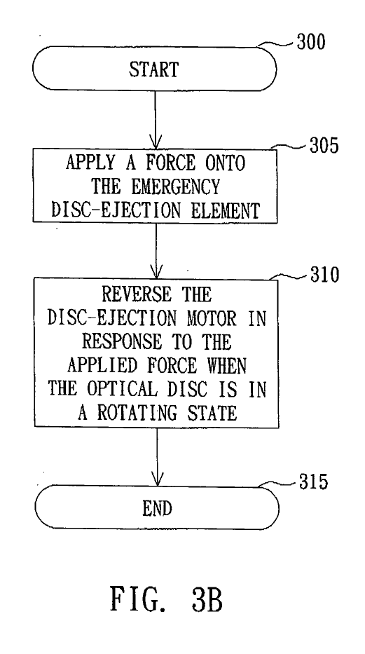

Referring to FIG. 2, a schematic diagram partly illustrates an optical disc drive according to the invention. In FIG. 2, an optical disc drive 200 functions with an optical disc, which can be carried with a tray, for example, a tray 250 of the optical disc drive 200. FIG. 3A is a block diagram illustrating an optical disc drive according to embodiment one of the invention.

The optical disc drive 200 mainly includes a driven module, a disc-ejection motor 230, an emergency disc-ejection element 240, a triggering switch 260, and a control unit. In addition, the driven module comprises a cam 220, and the control unit, not shown in FIG. 2, can be disposed anywhere in the optical disc drive. The driven module is coupled to the tray 250; the disc-ejection motor 230 is coupled to the driven module; the emergency disc-ejection element 240 is opposite to the cam 220 of the driven module.

When the optical disc drive 200 is functioning normally, the disc-ejection motor 230 can drive the driven module to withdraw the tray 250 from the optical disc drive 200. When the optical disc drive 200 is out of order, a mechanical method can be used to release the tray 250 from the optical disc drive 200 so as to eject the optical disc. The tray 250 can be forced to be released from the optical disc drive 200 by pushing the emergency disc-ejection element 240 with a straightened paper clip 270, or any tool with a straight part, such as a probe, rod, and so on. When the emergency disc-ejection element 240 is being pushed, an applied force F is applied to drive the cam 220 of the driven module so that the driven module drives the tray 250 to eject from the optical disc drive 200.

According to the invention, a triggering switch 260, a limit switch for instance, is disposed between the emergency disc-ejection element 240 and the cam 220. When anyone inserts a tool with a straight part, such as a straightened paper clip 270, a probe, or a rod, into the emergency disc-ejection hole while the optical disc drive 200 is reading a rotating optical disc, the force F provided by the emergency disc-ejection element 240 will activate the triggering switch 260 first.

FIG. 3A illustrates the operation of the emergency disc-ejection control method of disc drive 200. First, the emergency disc-ejection element 240 is pushed with a straight part, such as the straightened paper clip 270 of FIG. 2, so that the emergency disc-ejection element 240 provides an applied force F. Next, the applied force F activates the triggering switch 260 so that the triggering switch 260 outputs a triggering signal S1. The control unit is used for receiving the triggering signal S1, and outputting a disc-ejection motor control signal S2 when an optical disc is rotating in the optical disc drive 200. The disc-ejection motor 230 is employed to receive the disc-ejection motor control signal S2 and output a reverse force Fr which balances the applied force F so that the emergency disc-ejection element 240 cannot drive the cam 220, thus disabling ejection of the tray 250 from the optical disc drive. When the optical disc drive is functioning normally and is reading a optical disc, a reverse force Fr opposite to the applied force F will be applied at the same time and for the same duration of the existence of the applied force F, thereby ensuring that the tray 250 is restrained in the optical disc drive.

Moreover, referring to FIGS. 2 and 3B, FIG. 3B shows a flowchart of an emergency disc-ejection control method for an optical disc drive, as shown in FIG. 2, according to embodiment one of the invention. The optical disc drive 200 according to the invention is for reading the data stored in an optical disc. The optical disc drive 200 has a tray 250 which can be driven either by the disc-ejection motor 230 or by the emergency disc-ejection element 240. The tray 250 can be driven along with an arrow direction shown in the diagram and be withdrawn from a reading position 254 opposite to a tray's front end 252 to an unloading position where the optical disc to be unloaded. The emergency disc-ejection method includes the following steps. First, the method starts at step 300. Then, in step 305, a force F is applied to move the emergency disc-ejection element 240. Next, in step 310, when an optical disc is in a rotating state, a reverse force Fr opposite to the applied force F is applied to reverse the disc-ejection motor 230 so that the tray 250 is restricted in the optical disc drive 200. Lastly, move to step 315 to end the emergency disc-ejection control method.

The above method allows the optical disc drive to read a rotating optical disc without being interrupted. Even when the emergency disc-ejection element is activated by the straightened paper clip 270 by mistake, the optical disc drive can still continue its operation normally and the tray 250 will not be released or ejected from the optical disc drive, thereby avoiding damaging the optical disc or injuring the user.

Embodiment Two:

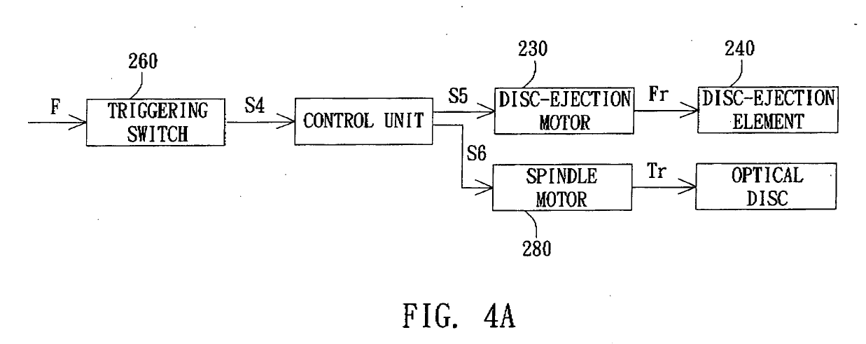

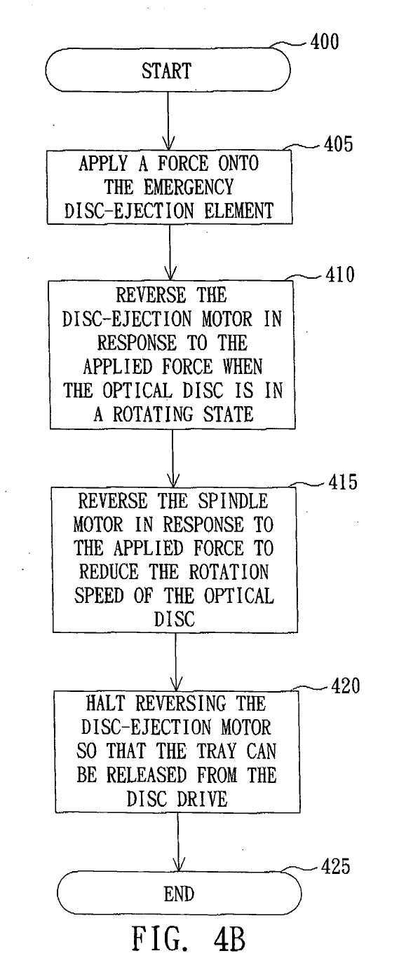

Referring to both FIG. 2 and FIG. 4A, FIG. 4A is a block diagram illustrating an optical disc drive according to embodiment two of the invention. In addition to all the elements included in the previous embodiment, the present embodiment further includes a spindle motor 210 for driving the optical disc to rotate, which is disposed in the optical disc drive 200 and is electrically coupled with a control unit.

When anyone inserts the straightened paper clip 270 or a rod into the emergency disc-ejection hole while the optical disc drive 200 is reading a rotating optical disc, a force F provided by the emergency disc-ejection element 240 will activate the triggering switch 260 first.

The emergency disc-ejection control method of disc drive 200 is illustrated with the optical disc drive as shown in FIG. 4A, wherein the straightened paper clip 270 of FIG. 2 is used to push the emergency disc-ejection element 240 such that the emergency disc-ejection element 240 provides an applied force F. The applied force F is used to activate the triggering switch 260 so that the triggering switch 260 outputs a triggering signal S4 in response to the applied force F. The control unit is employed to receive the triggering signal S4, and output a disc-ejection motor control signal S5 when the optical disc is rotating in the optical disc drive 200. The disc-ejection motor 230 is utilized to receive the disc-ejection motor control signal S5 and output a reverse force Fr which balances the applied force F so that the emergency disc-ejection element 240 cannot drive the cam 220, avoiding withdrawing the tray 250 from the optical disc drive.

The spindle motor 210 is used for receiving a spindle motor control signal S6 and outputting a reverse torque Tr which reduces the rotation speed of the optical disc drive. Then, the disc-ejection motor will discharge the reverse force Fr so that the tray 250 can be released from the optical disc drive 200.

Referring to both FIGS. 2 and 4B, FIG. 4B illustrates an emergency disc-ejection control method of an optical disc drive according to embodiment two of the invention. Comparing the emergency disc-ejection control method as shown in FIG. 3B with that as shown in FIG. 4B, steps 300 to 310 in FIG. 3B are similar to steps 400 to 410 in FIG. 4B. First, the method starts at step 400. Then, in step 405, a force F is applied to move the emergency disc-ejection element 240. Next, in step 410, when the optical disc is in a rotating state, a reverse force Fr opposite to the force F is provided to reverse the disc-ejection motor 230 so that the tray 250 is restrained in the optical disc drive 200.

After that, embodiment two particularly has two more steps, namely step 415 and step 420, than embodiment one has. Step 415 is to reverse the spindle motor 210 in response to the applied force F to reduce the rotation speed of the optical disc. Step 420 is to halt reversing the disc-ejection motor 230 so that the tray 250 can be released from the optical disc drive 200. The emergency disc-ejection control method then ends in step 315.

According to the above method, the tray 250 will not be released from the optical disc drive until the rotation speed of the optical disc carried by the tray 250 has been reduced to a much lower speed or has been brought to a halt if the emergency disc-ejection element is activated by the straightened paper clip 270 by mistake. Under this circumstance, although the optical disc drive cannot continue its operation, the optical disc can remain intact. Furthermore, an optical disc which is rotating slowly is less likely to injure anyone.

Embodiment Three:

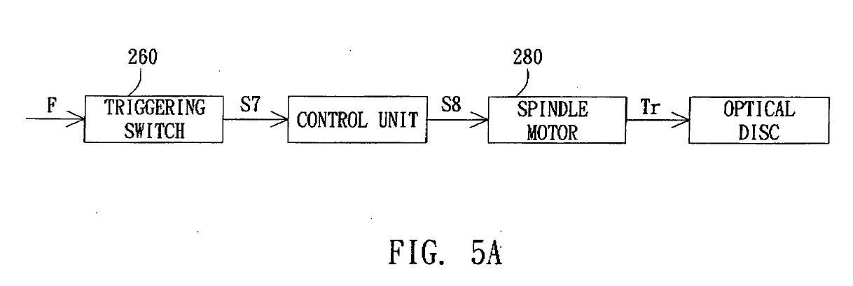

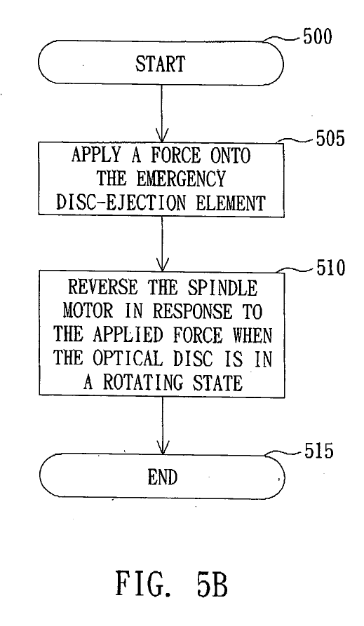

Referring to both FIG. 2 and FIG. 5A, FIG. 5A is a block diagram illustrating an optical disc drive according to embodiment three of the invention. The elements and the coupling relationship between these elements included in the present embodiment are identical to that included in embodiment two.

The disc-ejection control method of the optical disc drive 200 in the present embodiment is similar to that in the previous embodiment. First, the emergency disc-ejection element 240 is pushed, for example, with the straightened paper clip 270 of FIG. 2, such that the emergency disc-ejection element 240 provides an applied force F. Next, the applied force F is applied to activate the triggering switch 260 so that the triggering switch 260 outputs a triggering signal S7 in response to the applied force F. The control unit is employed to receive the triggering signal S7, and output a spindle motor control signal S8 when an optical disc is rotating in the optical disc drive 200. The spindle motor 210 is used for receiving the spindle motor control signal S8 and accordingly outputting a reverse torque Tr to reduce the rotation speed of the optical disc drive.

After that, the applied force F provided by the emergency disc-ejection element 240 drives the cam 220 of the driven module so that the driven module drives the tray 250 to eject from the optical disc drive.

Referring to FIGS. 2 and 5B, FIG. 5B is a flowchart showing an emergency disc-ejection control method of an optical disc drive according to embodiment three of the invention. The optical disc drive 200 according to the invention is for reading the data stored in an optical disc. The optical disc drive 200 has a tray 250 which can be driven either by the disc-ejection motor 230 or by the emergency disc-ejection element 240. The tray 250 can be driven along with an arrow direction shown in the diagram and be withdrawn from a reading position 254 opposite to a tray's front end 252 to an unloading position where the optical disc to be unloaded. The emergency disc-ejection method includes the following steps. First, the method starts at step 500. Then, in step 505, a force F is applied to move the emergency disc-ejection element 240. Next, in step 510, when an optical disc is in a rotating state, a reverse force Fr opposite to the force F is applied to reverse the spindle motor 210 to reduce the rotation speed of the optical disc drive 200. The emergency disc-ejection control method then ends in step 515.

The present method in embodiment three differs from the method in embodiment two in that the control unit does not output a disc-ejection motor control signal which controls the disc-ejection motor 230 to output an reverse force which prevents the cam 220 from being pushed by the emergency disc-ejection element 240.

According to the invention, disc-ejection safety protection is achieved in different situations. Normally, if the optical disc rotates in a high multiple speed (for example, the optical disc drive is reading or burning an optical disc in a high multiple speed), embodiment one and embodiment two can be used to ensure the safety of the optical disc. If the optical disc rotates in a low multiple speed (for example, the optical disc drive is reading or burning an optical disc in a low multiple speed), embodiment three can be used to ensure the safety of the optical disc.

The advantages of the above-disclosed embodiments according to the invention are described below. If anyone inserts a rod or a paper clip into the emergency disc-ejection hole when the optical disc drive is reading a rotating optical disc, the emergency disc-ejection element will activate the triggering switch first. Then, the triggering switch will output a triggering signal to the control unit which will respectively outputs a disc-ejection motor control signal and a spindle motor controlling signal to the disc-ejection motor and the spindle motor. Consequently, the tray will either be restrained in the optical disc drive or be released with so low a rotation speed that will neither damage the optical disc in use nor injure the user.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical disc drive for an optical disc which can be carried with a tray, the optical disc drive comprising:
a driven module coupled to the tray;
a disc-ejection motor coupled to the driven module;
an emergency disc-ejection element, the emergency disc-element, when being pushed, for providing the driven module with an applied force to drive the tray to be released from the optical disc drive;
a triggering switch for outputting a triggering signal corresponding to the applied force; and
a control unit, electrically coupled with the disc-ejection motor and the triggering switch respectively, for receiving the triggering signal, and outputting a disc-ejection motor control signal when the optical disc rotates in the optical disc drive;
wherein the disc-ejection motor outputs a reverse force opposite to the applied force when receiving the disc-ejection motor control signal so that the tray is restrained in the optical disc drive.

2. The optical disc drive according to claim 1, wherein the emergency disc-ejection element can be pushed with a tool with a straight part.

3. The optical disc drive according to claim 1, wherein the disc-ejection motor drives the driven module to drive the tray to be released from the optical disc drive when the optical disc drive is operating normally.

4. The optical disc drive according to claim 1, further comprising:
a spindle motor, electrically coupled with the control unit, for rotating the optical disc, wherein the control unit receives the triggering signal, and outputs a spindle motor control signal when the optical disc rotates; wherein the spindle motor receives the spindle motor control signal and accordingly outputs a reverse torque which reduces the rotation speed of the optical disc.

5. The optical disc drive according to claim 4, wherein the emergency disc-ejection element can be pushed by using a tool with a straight part.

6. The optical disc drive according to claim 4, wherein the disc-ejection motor drives the driven module to release the tray from the optical disc drive when the optical disc drive is operating normally.

7. An optical disc drive for an optical disc which can be carried with a tray, comprising:
a spindle motor disposed in the optical disc drive for driving the optical disc to rotate;
a driven module coupled to the tray;
a disc-ejection motor coupled to the driven module;
an emergency disc-ejection element, when being pushed, for providing the driven module with an applied force to release the tray from the optical disc drive;
a triggering switch for outputting a triggering signal corresponding to the applied force; and
a control unit, electrically coupled with the spindle motor and the triggering switch, for receiving the triggering signal, and outputting a spindle motor control signal when the optical disc rotates in the optical disc drive;
wherein the spindle motor outputs a reverse torque which reduces the rotation speed of the optical disc drive when receiving the spindle motor control signal.

8. The optical disc drive according to claim 7, wherein the optical disc drive rotates in a lower rotation speed.

9. The optical disc drive according to claim 7, wherein the emergency disc-ejection element can be pushed by using a tool with a straight part.

10. The optical disc drive according to claim 7, further comprising a disc-ejection motor, electrically coupled with the driven module and the control unit, wherein the disc-ejection motor drives the driven module to release the tray from the optical disc drive when operating normally.

11. An emergency disc-ejection control method for an optical disc drive, wherein the optical disc drive is for use with an optical disc which is carried with a tray that can be driven and withdrawn from a reading position to an unloading position by a disc-ejection motor or an emergency disc-ejection element, wherein the method comprises the steps of:
applying a force onto the emergency disc-ejection element; and
reversing the disc-ejection motor in response to the applied force so that the tray is restrained in the optical disc drive when the optical disc is in a rotating state.

12. The emergency disc-ejection control method for an optical disc drive according to claim 11, wherein the optical disc is driven by a spindle motor and following the step when the optical disc is in a rotating state further comprises the steps of:
reversing the spindle motor in response to the applied force so as to reduce the rotation speed of the optical disc drive; and
halting reversing the disc-ejection motor so that the tray can be released from the optical disc drive.

13. An emergency disc-ejection control method for an optical disc drive, wherein the optical disc drive for an optical disc which is carried with a tray that can be driven and withdrawn from a reading position to an unloading position by a disc-ejection motor or an emergency disc-ejection element, wherein the method comprises the steps of:
applying a force to move the emergency disc-ejection element; and
reversing the spindle motor in response to the applied force so as to reduce the rotation speed of the optical disc.
